(19) United States
(12) Patent Application Publication
(10) Pub. No.: US 2014/0331557 A1
(43) Pub. Date: Nov. 13, 2014

(54) Integrated industrial door control and reporting system and method

(71) Applicants: Rik Bruns, Belvidere, IL (US); Ron Seyk, Algonquin, IL (US); Anders Sivebaek Nielsen, Kirke Hyllinge (DK); Rene' Joergensen, Charlottenlund (DK)

(72) Inventors: Rik Bruns, Belvidere, IL (US); Ron Seyk, Algonquin, IL (US); Anders Sivebaek Nielsen, Kirke Hyllinge (DK); Rene' Joergensen, Charlottenlund (DK)

(73) Assignee: BTR CONTROLS, INC., Elgin, IL (US)

(21) Appl. No.: 13/890,962

(22) Filed: May 9, 2013

(51) Int. Cl. E05F 15/20; E05F 15/10

(52) U.S. Cl. CPC E05F 15/2076; E05F 15/10; E05F 15/20
USPC 49/25; 49/506

(57) ABSTRACT

A system for integrating industrial doors into a total system for monitoring and control of a building, warehouse or group of buildings. Controllers for each door motor have absolute position shaft encoders that provide the exact shaft position to a controller system that allows real-time control of torque and current. Each motor controller can communicate bidirectionally over a wireless (or wired) network with other controllers and/or with one or more designated locations. Each controller can provide data over the network from any sensor or data collection device at the controller, motor or door. A program executing on a PC, laptop, tablet, smartphone can communicate with any or all of the controllers, integrate control of multiple doors, perform statistical analysis on collected data from each door and provide real-time security functions as well as long term trend data, energy usage and loss and predictive analytics.

### BACKGROUND

1. Field of the Invention

The present invention relates generally to the field of industrial door control and more particularly to an integrated industrial door control system and method.

2. Description of the Prior Art

An industrial door is typically a sliding overhead door on a building or warehouse. Most slide vertically or horizontally to open or close. Many are large enough for various types and sizes of vehicles to pass through. Control of industrial doors has historically been on an individual door-by-door basis. Typically, each door has had its own motor and motor controller as well as buttons or other types of activators to cause it to open or close. Usually, there is no way to determine if a door is open or closed without visual inspection, although some doors have been equipped with switches that are hard-wired to a light somewhere to indicate the door state (open or closed).

Industrial motor controllers can be found from simple, open-loop motors to sophisticated controllers using embedded microprocessors with motor position encoders, resolvers or Hall Effect sensors, phase monitoring and other features. Many industrial door motor controllers tend to be on the simpler side due to cost. For safety, there are usually force or torque sensors that shut the motor down if the door jams or encounters an obstacle. Most position encoders report position using either pulses or some sort of analog or digital signal relating to the motor shaft position. It would be advantageous for a shaft encoder to be able to report both in a pulse format and in analog or digital format.

Most industrial motor controllers use a stored acceleration curve for motor motion. In most cases, this is fixed, stored in the motor controller, and never changed. It would be advantageous to have a system where a motor acceleration curve (or curves) as well as torque could be dynamically changed as needed to achieve optimum performance from the motor under changing conditions.

For safety, many industrial doors are surrounded by an RF system that incorporates sensors to sense the presence of a person or object near the door and sends a safety signal to the motor controller.

Because prior art systems typically operate one door at a time, it would be very advantageous to have a system that tied multiple industrial doors (preferably all the doors in a facility) together with a communications network and protocol preferably wireless. This way, each door can be integrated into the total process. For example, shipping and receiving facilities can have hundreds of doors located along the entire perimeter of the facility.

Also in prior art systems, there were no records of how long a door spent open (or closed), when it was opened, how much power was being used, how much building heat was being wasted through open doors, and the like. It would therefore be very advantageous to have a system that would allow tracking these and other parameters on a site-wide basis. It would also be very advantageous to have a two-way communication system, preferably wireless, that would allow data to be taken from a particular controller and/or a particular door and also allow data to be sent to a particular controller from a remote control point. This way, controllers can supply any type of data needed by the enterprise to a central location or designated locations and can be programmed or re-programmed from a central location either to change performance parameters or to acquire and report different data.

### SUMMARY OF THE INVENTION

The present invention relates to a system for integrating industrial doors into a total process for a building, warehouse or group of buildings including monitoring and controlling multiple doors. Motor controllers for each door motor have absolute position shaft encoders that provide the exact shaft position to a closed loop controller system that allows real-time control of torque, frequency and current. Each motor controller can communicate bidirectionally over a wireless (or wired) network with other controllers and with one or more central locations. The network includes a data protocol that is optimized for motor control. Each controller can provide data over the network from any sensor or data collection device present at the controller, motor or door.

Safety systems such as obstacle sensors or RF presence sensors such as those that surround a door can be integrated into the system as well as all other safety systems, but in addition, can be provided with a separate local RF communications network that allow these sensors to directly communicate with actuators.

A program executing on a PC, laptop, tablet, smartphone or any other type of processor can communicate with any or all of the controllers, integrate control of multiple doors, perform statistical analysis on collected data from each door or door controller and provide real-time security functions as well as long term trend data, energy usage and loss and predictive analytics. Controllers can wirelessly communicate with other controllers directly to create special types of door combinations like airlocks.

### DESCRIPTION OF THE FIGURES

The following figures are now presented to illustrate features of the present invention:

FIG. 1 shows a block diagram of an embodiment of the present invention with multiple doors.

FIG. 2 shows a single controller with a wireless remote switch and a shaft position encoder.

FIG. 3 shows a block diagram of a motor control system according to the present invention showing a single motor and controller.

FIG. 4 shows a block diagram of a single motor, controller and encoder as well as a safety sensor communicating with an actuator on a separate wireless network.

Several drawings and illustrations have been presented to aid in understanding the present invention. The scope of the present invention is not limited by what is shown in the figures.

### DESCRIPTION OF THE PREFERRED EMBODIMENT

The present invention relates to a system for integrating industrial doors into the total process for a building, warehouse or group of buildings. Integrating all of the industrial doors in a building for example can lead to the collection of information about the doors including traffic flow, security, energy usage, door states and the like. Wireless reporting leads to a system that can be installed in existing structures without having to change out doors or motors.

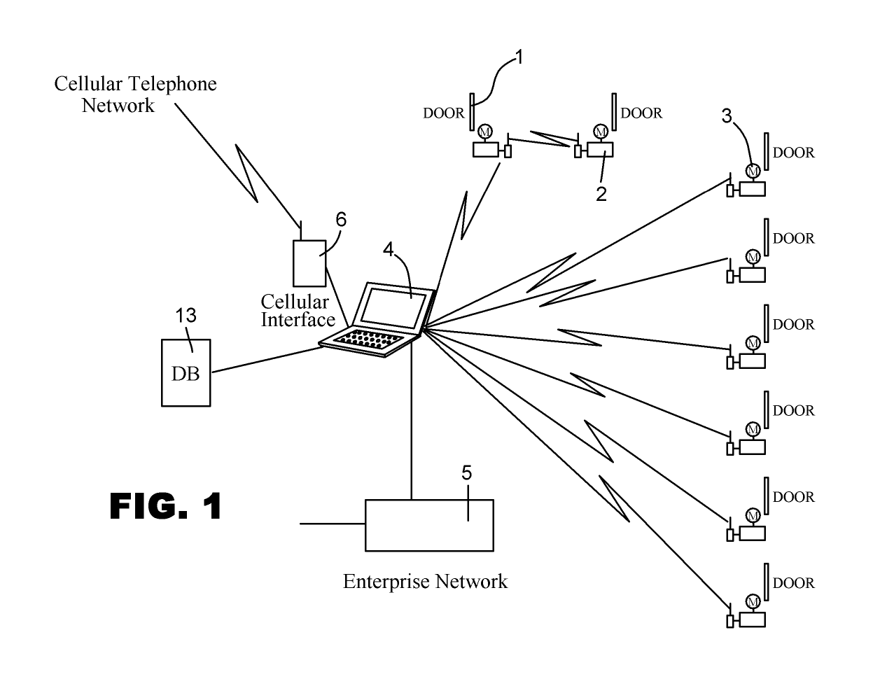

FIG. 1 shows a system that integrates a large number of doors in a building. Each door typically includes the mechanical door itself 1, a door motor 3, a motor controller 2, and various switches associated with opening and closing the door. Motors 3 found in industrial door applications may range from small 100 V single phase units to very large, higher voltage, 3-phase types. Door motors cannot just be powered up and run—they must be controlled by a smart controller unit 2 that typically uses a sensor to sense motor shaft position, provides acceleration and torque control, coordinates the state of external switches and performs basic door safety functions. A key feature of the present invention is a smart motor controller that can perform these and other functions, can replace existing controllers and that can communicate using a smart protocol with other similar controllers and with one or more remote control or data collection points 4.

A remote point 4 in FIG. 1 is shown as a laptop computer. However, any type of computer may be used including a PC, server, tablet or any other type of dedicated or non-dedicated processor. This computer or processor, as well as having local memory, can be associated with memory and storage devices, both local and remote including remote databases 13. In addition, the remote point 4 can be optionally connected into an enterprise computer network 5. This can be done via Ethernet™, WiFi or other wireless technique, direct cabling, or by any other type of direct or indirect connection. In addition, a remote point 4 can optionally be coupled through a cellular interface 6 into the cellular telephone network.

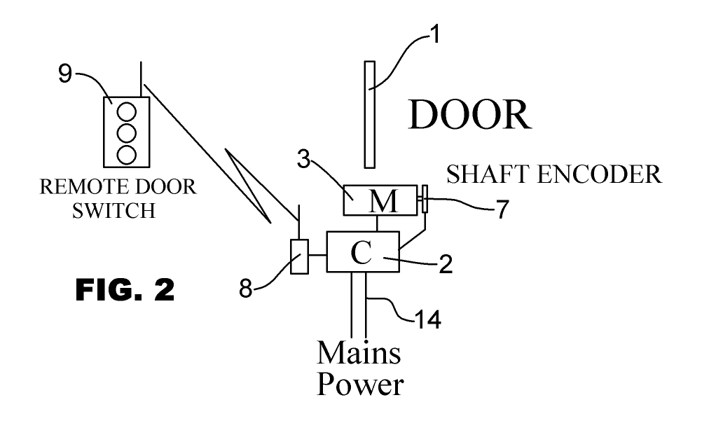

FIG. 2 shows a single door 1. A motor 3 is electrically driven by switched and controlled power connections from a controller 2. The motor typically has a shaft encoder 7 that can accurately report the shaft position of the motor 3 to the controller 2 in real time. The controller is supplied with electrical power from electrical mains 14 (typically 460 volts, 230 volts, 208 volts or 120 volts, 60 Hz in the U.S.). The controller converts this to the correct voltage and number of phases for the particular motor being used. It is possible to supply the controller 2 with any mains voltage available. The controller 2 contains a wireless interface 8 that allows low power RF radio communication within a building. While low power RF communication is the preferred method of communicating, any other type of wired or wireless communication is within the scope of the present invention.

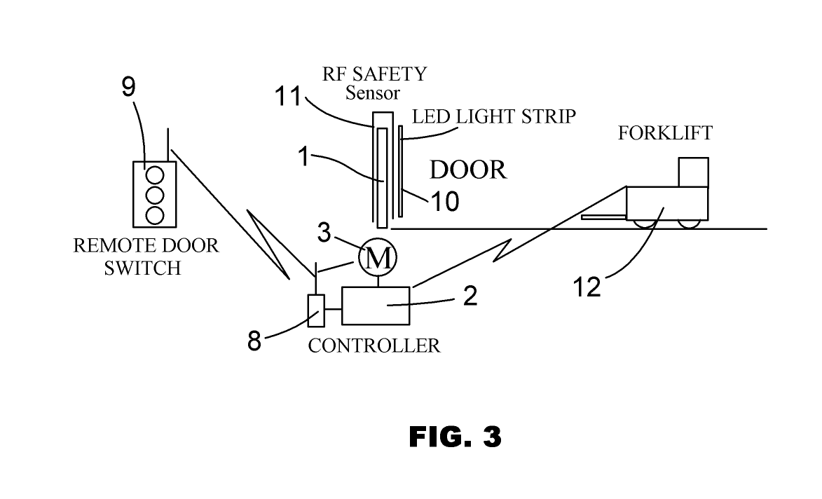

FIG. 3 shows the motor 3 and motor controller 2 of FIG. 2 with additional accessories. In particular, one or more wireless door switches 9 can be configured to work with the controller 2 just as hard-wired switches would. The door 1 can have an LED light strip or other safety lighting system 10 that can be controlled by the controller 2. In addition, doors may have RF sensors 11 around them that sense persons or objects in or near the door. These can also be read and controlled by the controller 2. Finally, vehicles approaching the door such as a forklift 12 may have RF communication with the controller to control the door.

As has been stated, a key feature of the present invention is a smart controller 2. While, numerous motor controllers are on the market and known in the art, the controller that is included in the present invention combines a unique set of features.

A door motor controller converts line power to motor power allowing it to control acceleration and torque as well as keeping track of the exact conditions present on the door. Line main power can be 110-120 V, single phase; 200-240 V. single phase; 200-240 V, 3-phase or 400-480, 3-phase. Line frequency can range from 50-60 Hz. Voltages supplied to motors can be 0-230 V, 3-phase, 0-250 Hz, or 0-460 V, 3-phase, 0-250 Hz. Input currents can run from 5-16 Amps, while output currents can run up to 8 Amps. 3-phase systems can be either star or delta configured. Other combinations of voltages, phases, frequencies and currents are within the scope of the present invention. A motor controller may use external, high power resistors called brake resistors that are used to dissipate current from the motor. A controller should be able to use 100-200 Ohm, 100 Watt or greater resistors. In addition, a controller should provide several input ports that can be sensed by an internal processor and acted upon by internal control software or firmware and be able to control several output ports and several power-capable relays.

The heart of motor control is typically provided by a shaft encoder that provides either pulse (or incremental), digital or analog (absolute) motor shaft position to the controller. A smart controller should be able to read shaft position in any of these formats and keep very accurate control of the exact real-time shaft position. A controller should be able to accept inputs from shaft encoders on the market and from a special shaft encoder according to the present invention. Incremental encoders must usually be used with a reference switch that allows at least one known door position. Also, sometimes it is desirable or necessary to attach the encoder after a gear. In this case, the controller must compensate for the gear ratio. This information can be entered into the controller at installation time.

A door controller must also be able to accept inputs from door safety switches and act on their status. Safety switches can be optical, magnetic or simply mechanical. It must also provide direct electrical outputs for several door states including door moving, door not moving, door open, door closed, door not closed, door open partial, door opening, door closing, door action delayed and other door states. In addition, it should provide a direct electrical output indicating an error state.

The door controller of the present invention also includes a way to program it both locally using a touch pad or touch screen and remotely using the wireless network. Local programming is allowed upon passing of a security check (such as an ID and/or Password) and is usually accomplished by the use of a hierarchy of menus. Remote programming uses various codes in a wireless protocol. Items that need to be programmed include timer values for activations, alarms, counters, limits and other information.

The smart controller of the present invention uses an internal processor that can collect all incoming motor data, process this data, and provide voltages to the motor as well as all outgoing signals and messages. This internal processor has local memory and can access data from remote databases over the wireless network if needed. The controller processor can execute algorithms that dynamically change or adjust the energy being used by the door motor.

In particular, the controller is always aware of motor current, motor slip and motor voltage. This allows control of power and torque and allows the economization of power. The controller is also aware of measured frequency from the motor in Hz as well as output frequency being applied to the motor. These values correlate to the real-time speed of the motor

Because there are many, many different parameters that a motor controller can manipulate, it is efficient to have a selection of pre-selectable or pre-configured profiles that can be used with different types of doors on the market. In addition, users may want to store their own custom profiles. It is efficient to have a default profile or set of parameters that a user can easily return to. All of these can be selected (or programmed) locally at the controller or remotely over the wireless network. All system profiles are also stored in a remote data base for easy access.

It is also desirable to allow users set door limits and some door parameters locally, either at the time of installation or later during use. The following are some of the parameters that may be set: fully open position, pre-open position, partial open positions, position of photocell or other sensor off, position of reverse edge off, pre-closed position and fully closed position.

Also, the controller must accept various parameters concerning the motor such as its speed rating (NP speed), a base frequency at which full voltage can be delivered to the motor during a door opening cycle, a base frequency at which full voltage can be delivered to the motor during a door closing cycle, required torques during opening and closing and DC brake current in conjunction with braking time. Additional parameters include motor ramp accelerations and frequencies. These parameters can come from predetermined profiles or can be entered or programmed either locally or remotely.

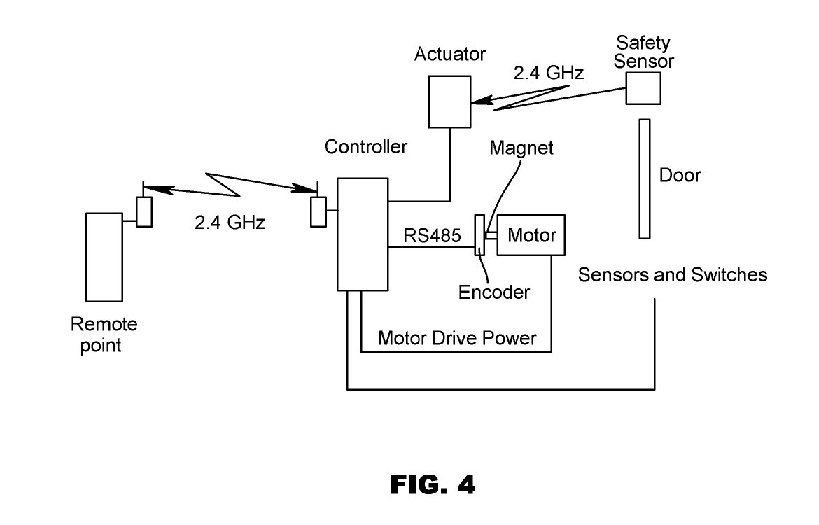

A previously stated a shaft encoder is a very important to motor control. A motor controller is extremely limited in what it could do without a shaft encoder. Many prior art shaft encoders have used rotating parts. This is undesirable from a reliability standpoint. The present invention includes a shaft encoder with no moving parts. A separate rotating magnet assembly fits on the motor shaft while the encoder senses the corresponding magnetic field. The magnet assembly can be supplied to fit any number of standard motor shafts. The encoder in this manner can provide a continuous digital output of absolute shaft position even after a power loss and during a power loss with internal battery backup. In addition, the encoder of the present invention can provide a secondary pulse or incremental output required by some controllers or in some countries. The encoder can provide a reliable hard-wired output to the controller using a standard electrical signal level such as RS 485 or other standard. The encoder can typically signal N bits of shaft position leading to a resolution of 2̂N absolute position steps. In addition, the encoder of the present invention can optionally provide an analog output for continuous resolution. Because of the high shaft position resolution, the controller can accurately control motor output torque in a closed loop configuration. FIG. 4 shows a diagram of a controller and encoder.

Due to the physical conditions encountered by the encoder, it is desirable to package the control in a molded package that is waterproof and sealed from environmental dirt, particles, grease, oil and the like. All internal components must be resistant to shock and vibration.

Due to the noisy environment of the motor and controller, it is preferred to hard-wire the encoder to the controller as described above. However, it is within the scope of the present invention to use any other technique or method to transfer information from the encoder to the controller including any wireless technique.

The preferred method uses serial half-duplex RS 485 communication with a bit rate of 19,200 bits per second (19.2 kBaud) with 8 data bits, 1 stop bit. Parity and/or check bits are optional. While this is the preferred data rate and bit configuration, any other data rate that can keep up with the motor rotation at the highest motor speeds is within the scope of the present invention. Also, any serial configuration of stop, start and parity bits can be used. Position reporting is typically accomplished using three data bytes (24 bits). A checksum byte is typically included to prevent a faulty reading from a communications error. While an 8 bit checksum is preferred, any other length or error-checking method can be used. The position is usually reported as the result of an incoming command. Since this command is the main incoming command of the encoder, it should execute very rapidly. The preferred method is to use a 1 byte command to request position. Position is then returned typically as three data bytes as described. Pulse output formats are also available and can be chosen by sending specific commands to the encoder. Typical values are 12, 20 or 50 pulses per shaft revolution. The encoder can also accept commands that allow programming of its flash memory (at higher data rates), and commands that report back serial number and/or current firmware version. FIG. 4 shows a typical encoder, controller and motor according to the present invention.

Commands to a encoder can be classified into two basic types: 1) those that cause a serious change in the encoder behavior and 2) those that do not. An example of the first type might be a sleep command. This command can shut down the encoder. A command of the second type might be a simple request for current shaft position. Commands of the second type can be short for fast response, while commands of the first type can be more complex with safeguards to prevent any type of data corruption from accidentally triggering such a command. These safeguards can take the form of groups of bytes that have a unique checksum for a valid command or any other technique.

As stated above, the controllers of the present invention can communicate with each other and with remote points such as shown in FIG. 1. To accomplish this, the preferred method is an RF wireless link operating in the 2.4 GHz ISM band (where a specific license is not required). Operation in this band can run up to 63 mW output power (18 dBm) and can communicate unobstructed for about 300 feet using a receiver with sensitivity of −94 dBm. Typically, output power can be adjusted downward when a full 18 dBm is not needed (this also increases battery life). This system can handle packet data communications, and can run for years on standard batteries. This is also shown in FIG. 4.

Using the RF wireless units described above (or any other communication technique or method), a computer located at a remote or control point can communicate with any and all door controllers within wireless range. In multiple building complexes, wireless links can be augmented by wired links between different buildings. Also, a pair of door controllers on a special set of doors such as an airlock can communicate with each other locally over a separate RF communications path making it impossible, for example, to open both doors at the same time.

A specialized protocol can be used in the wireless system that is adapted with special commands and responses concerning doors. All door and motor parameters can be communicated from each controller to the control point. Also, any controller can be reprogrammed from the control point under proper authority and security checks. For safety and security reasons, it is standard practice to not directly command any door to open or close from a remote location. That way, even if a security threat could enter the communications system (say via a connection to an enterprise system), it could not command doors to open. However, the computer located at the remote point can sense and monitor the state of all doors. This set of door states can be reported to a security location in real time. This way, it is possible to make sure that all doors are closed when they are required to be, and if a door is opened, there can be a security report and logging of the event.

The wireless communication protocol can be based on packets or short messages. Various types of modulation may be used including spread spectrum techniques such as code division multiplex. This type of coding can be used to prevent different controllers from interfering with each other. In another embodiment, each controller can be polled or can be addressed by the control point using a unique controller ID. In this type of system, a particular controller only responds when interrogated by ID.

The present invention allows monitoring of energy usage by the doors themselves and also estimates of energy losses through open doors based on external weather and temperature conditions. Algorithms running at the remote point can optimize traffic patterns in some cases to minimize energy loss. The number of times a door has cycled can be logged and used to schedule regular maintenance. Predictive analytics can be used to determine maintenance intervals on a door-by-door basis. Any door in service that reports a number of error conditions above a predetermined threshold can also be scheduled for immediate maintenance.

Since real-time motor current on any door can be logged and monitored by the computer, periodic reports of actual door energy usage can be generated. For example, an enterprise may determine that a particular door is being cycled too often and that it might be more economical to leave it open during certain hours. Also, because energy loss through open doors can be monitored, it may be determined that it makes sense to install airlocks or the like on particular doors.

The present invention allows predictive analytics to be performed at the control point or in other processors. This is statistical analysis that attempts to predict future door conditions such as failures. This is possible because any motor or controller parameter that can be measured can be communicated back and used in the analysis. These parameters include current, torque, temperature, counts, cycle times, errors and any other parameter. Reduced statistical data concerning a particular motor or door or groups of motors and doors can be presented on displays or as printouts from printers.

As shown in FIG. 1, the remote point can optionally communicate through the cellular telephone network. It can thus be wirelessly connected to another telephone or to the Internet. The remote point can of course be wired to the Internet as well. This can allow authorized personnel to access door state data and trend data from truly remote locations such as a corporate headquarters. This can help in corporate planning since, in the past, enterprises had no idea of the state or energy usage or loss through any of hundreds of industrial doors.

An integrated wireless LED signaling system can also be incorporated. This system is programmed using any of the included controller output functions.

An RF system incorporating security tags can be used on vehicles to identify authorization through the Enterprise level system. The system would pass this information to the door controller and only allow the identified vehicle to access the door.

A second, separate RF system using similar local wireless communication can connect safety sensors and activation controls. This allows independent private communications between local safety sensors and local activators so that controls that locally operate doors can be prevented or allowed to operate solely on the state of various safety sensors. It also eliminates the need for wiring between sensors and activators.

Several descriptions and illustrations have been presented to aid in understanding the present invention. One with skill in the art will realize that numerous changes and variations may be made without departing from the spirit of the invention. Each of these changes and variations is within the scope of the present invention.

We claim:

1. An integrated industrial door control and data collection system comprising:
a plurality of industrial door controllers each adapted to control an industrial door motor, said industrial door motor equipped with an absolute shaft position encoder in data communication with one of said door controllers;
each of said door controllers including a closed-loop control system that can directly control motor torque of a connected motor in real-time, and can also measure in real-time a plurality of motor parameters relating to said connected motor;
a bidirectional wireless communications module electrically connected to each of said door controllers, said wireless communication module adapted to transmit wirelessly at least some of said plurality of motor parameters or associated door state information to at least one remote processor using a wireless communications network;
said remote processor executing instructions that perform statistical analysis on said motor parameters or said door state information.

2. The integrated industrial door control and data collection system of claim 1 wherein said bidirectional wireless system is a radio system.

3. The integrated industrial door control and data collection system of claim 2 wherein said bidirectional wireless system operates on 2.4 GHz.

4. The integrated industrial door control and data collection system of claim 1 wherein said statistical analysis includes predictive analytics.

5. The integrated industrial door control and data collection system of claim 1 wherein said at least some of said door motor controllers control frequency of power applied to an associated motor.

6. The integrated industrial door control and data collection system of claim 1 wherein at least one of said door motor controllers can communicate directly with another of said door motor controllers.

7. The integrated industrial door control and data collection system of claim 6 wherein said at least one of said door motor controllers is part of an airlock pair of controllers.

8. The integrated industrial door control and data collection system of claim 1 wherein at least one of said door motor controllers also controls an LED light strip associated with an associated door.

9. The integrated industrial door control and data collection system of claim 1 wherein data communication between said door motor controllers and said shaft encoders is bidirectional serial data on an electrical link according to standard RS 485.

10. The integrated industrial door control system of claim 1 wherein said shaft position encoders have no moving parts.

11. The integrated industrial door control and data collection system of claim 1 further comprising a second wireless communication network allowing independent communication between at least one safety sensor and at least one door actuator electrically connected to said industrial door motor.

12. An industrial door system comprising:
A door motor controller adapted to drive an AC door motor, said door motor having an absolute shaft position encoder in electrical communication with said door motor controller, said door motor controller controlling torque in real time;
said door motor controller adapted to wirelessly communicate with at least one remote control point, said door motor controller sending a plurality of motor parameters to said remote control point over a wireless communications network;
a processor at said remote control point executing stored instructions to statistically reduce data sent from said door motor controller, said processor presenting reduced data concerning said AC door motor to a display or printer.

13. The industrial door system of claim 12 wherein said door motor controller can directly communicate wirelessly with another door motor controller controlling a different AC door motor.

14. The industrial door system of claim 12 wherein said door motor controller can directly communicate wirelessly with another door motor controller controlling a different AC door motor to form a pair of cooperating AC door motors on an airlock.

15. The industrial door system of claim 12 wherein said data sent from said door motor controller is used to conserve energy.

16. The industrial door system of claim 12 further comprising a second wireless communication network allowing independent communication between at least one safety sensor and at least one door actuator attached to said AC door motor.

17. A method of industrial door control comprising:
providing an industrial door motor controller adapted to drive an AC door motor;
providing an absolute motor shaft position encoder on said AC door motor;
providing digital communication between said position encoder and said door motor controller allowing real-time control of motor torque;
providing a wireless communications network between said door motor controller and a remote reporting point, said door motor controller adapted to send a plurality of motor and door parameters to said remote reporting point over said wireless network;
providing a set of executable computer instructions adapted to run on a processor at said remote reporting point storing and displaying statistical data derived from at least some of said plurality of motor and door parameters.

18. The method of claim 17 further comprising providing a second wireless communication network allowing independent communication between at least one safety sensor and at least one door actuator attached to said AC door motor.

19. The method of claim 17 further including at least one sensor in communication with said industrial door motor controller.
